(19) United States
(12) Patent Application Publication
(10) Pub. No.: US 2016/0171576 A1
(43) Pub. Date: Jun. 16, 2016

(54) FUNCTIONALLY INTERRELATED USER INTERFACES FOR CONDUCTING TRANSACTIONS

(71) Applicant: Auction.com, LLC, Irvine, CA (US)

(72) Inventors: Katherine Dryden, San Diego, CA (US); Dave Mercer, Spring Valley, CA (US)

(21) Appl. No.: 14/956,383

(22) Filed: Dec. 1, 2015

Related U.S. Application Data
(63) Continuation-in-part of application No. 14/463,610, filed on Aug. 19, 2014.
(60) Provisional application No. 62/086,143, filed on Dec. 1, 2014.
(60) Provisional application No. 61/868,932, filed on Aug. 22, 2013.

(51) Int. Cl. G06Q 30/06; G06Q 50/16; G06Q 50/18

(52) U.S. Cl. CPC G06Q 30/0611; G06Q 50/188; G06Q 50/167; G06Q 30/0641

(57) ABSTRACT

A negotiation panel can be provided to enable a buyer and a seller to exchange messages over a communication network. The contract term negotiation panel may identify a list of contract terms which are open for negotiation between the buyer and the seller. The computer system may provide the negotiation panel and the contract term negotiation panel to be functionally interrelated, by (i) parsing messages of the negotiation panel to detect a match condition with respect to a material term for the transaction, (ii) identifying a corresponding contract term displayed through the contract negotiation panel for the match condition, and (iii) indicating the corresponding contract term as complete.

### CROSS-REFERENCE TO RELATED APPLICATIONS

This application incorporates by reference the following applications: (1) Provisional U.S. patent application Ser. No. 62/086,143, entitled “NEGOTIATION AND MANAGEMENT SYSTEM FOR ONLINE SALES TRANSACTION,” filed on Dec. 1, 2014; and (2) U.S. patent application Ser. No. 14/463,610, entitled “ONLINE REAL ESTATE TRANSACTION SYSTEM,” filed on Aug. 19, 2014, which claims priority to U.S. Provisional Patent Application No. 61/868,932, entitled “ONLINE REAL ESTATE TRANSACTION SYSTEM,” filed on Aug. 22, 2013; all of the preceding priority applications being hereby incorporated by reference in their respective entirety.

### TECHNICAL FIELD

Examples relate to user interfaces, and more specifically, to functionally interrelated user interfaces for conducting transactions.

### BACKGROUND

Traditional methods for managing and conducting sales transactions involving substantial assets are generally cumbersome, time-consuming, and unsatisfactory. One example is a real estate transaction that involves complicated back-and-forth negotiations. In a traditional real estate transaction, a buyer's real estate agent generally prepares a standard contract based on the buyer's terms and transmits (e.g., via email or fax) the standard contract, as an offer, to the listing agent to review. The listing agent can show the offer to the seller for approval, or make changes to terms in the contract as a counter-offer to the buyer's agent in a similar fashion. This process typically repeats itself multiple times until a transaction is fully negotiated. What generally results is a final document that is arcane and difficult for the layman seller and buyer to interpret, thereby exposing the parties and their agents to unnecessary risk of dispute and litigation. Moreover, it can be difficult to manage multiple ongoing or potential negotiations under this process.

In some instances, buyers and sellers may want to save costs by completely removing intermediary parties (e.g., real estate agents, attorneys, insurers, etc.). However, buyers and sellers expose themselves to similar risks of dispute and litigation, as they may not know all of the intricacies involved, such as all of the terms to be negotiated, the timing, and the accompanying paperwork.

These same or similar problems also exist in contexts other than real estate, such as automobile sales, construction projects, service contexts, and the like. No satisfactory solution exists for managing and conducting sales transactions.

### BRIEF DESCRIPTION OF DRAWINGS

The technology introduced here may be better understood by referring to the following Detailed Description in conjunction with the accompanying drawings, in which like reference numerals indicate identical or functionally similar elements.

FIG. 1 is a block diagram illustrating a network-based environment within which the transaction management technology can be implemented, in accordance with some embodiments.

FIG. 2 is a block diagram of example components of a server (e.g., a transaction manager server) in accordance with some embodiments of the transaction management technology.

FIG. 3 is a flowchart illustrating an example process for facilitating an online real-estate sales transaction in accordance with some embodiments.

FIG. 4 is a flowchart illustrating an example process for facilitating a negotiation between a buyer and a seller in a real-estate sales transaction in accordance with some embodiments.

FIG. 5 is a flowchart illustrating an example process for performing additional operations associated with a detected match condition between buyer and seller inputs, in accordance with some embodiments.

FIG. 6 is a flowchart illustrating an example process for finalizing the sales transaction in accordance with some embodiments.

FIGS. 7-17 show examples of various screen displays that can be generated by the transaction manager server and loaded onto a user device.

FIG. 18 depicts a diagrammatic representation of a machine in the example form of a computer system within which a set of instructions, for causing the machine to perform any one or more of the methodologies discussed herein, can be executed.

### DETAILED DESCRIPTION

According to examples, a computer system provides multiple user-interfaces or portions thereof which are functionally interrelated to enable negotiation and progressive completion of a set of terms amongst parties of a transaction. According to one example, a system is implemented to provide a negotiation panel and a contract term negotiation panel. The negotiation panel can be provided to enable the buyer and seller to exchange messages over a communication network. The contract term negotiation panel may identify a list of contract terms which are open for negotiation between the buyer and the seller. The computer system may provide the negotiation panel and the contract term negotiation panel to be functionally interrelated, by (i) parsing messages of the negotiation panel to detect a match condition with respect to a material term for the transaction, (ii) identifying a corresponding contract term displayed through the contract negotiation panel for the match condition, and (iii) indicating the corresponding contract term as complete.

A negotiation panel can be provided to enable a buyer and a seller to exchange messages over a communication network. The contract term negotiation panel may identify a list of contract terms which are open for negotiation between the buyer and the seller. The computer system may provide the negotiation panel and the contract term negotiation panel to be functionally interrelated, by (i) parsing messages of the negotiation panel to detect a match condition with respect to a material term for the transaction, (ii) identifying a corresponding contract term displayed through the contract negotiation panel for the match condition, and (iii) indicating the corresponding contract term as complete.

Examples as described provide a network service, computer system, and online forum by which functionally interrelated panels (or display regions of a user interface) are generated separately enable negotiations (through network based communications) and memorialization of instances when the negotiations achieve agreement amongst the parties. According to some examples, the use of functionally interrelated panels or display regions can promote or enable online sales transaction between a buyer and a seller in a manner that eliminates the need for human involvement, whether by interested third-party or by intermediary. Examples further provide a negotiation and management platform system (also referred to herein as “the transaction management technology”), without necessitating the use of an agent. As used here, the term “online sales transaction” refers to a sales transaction conducted over a communications network (e.g., the Internet). As used here, the term “agent” refers to any intermediary individual (e.g., a real estate listing agent) typically involved in a sales transaction.

In some examples, a server or combination of servers implement a network service for implementing a network-based negotiation and management platform or platform system (hereinafter, “NMPS”), through which negotiations and other activities can be conducted by parties of a transaction (e.g., buyer and seller). In examples, users can operate user devices (e.g., mobile computing devices), with functionality that may be specific to a role of the user as either buyer or seller. Still further, in some examples, a buyer and seller, through an application installed on their respective user devices, can access the NMPS over a communications network, e.g., the Internet, to list, view, negotiate, and complete a sales transaction directly with each other. In some embodiments, the application can be a web browsing application that enables access to a website and/or web pages hosted by the NMPS. In some embodiments, the application can be a mobile transaction management application executed by the NMPS over a wireless communications network (e.g., a Wireless Local Area Network (WLAN) and/or a cellular telecommunications network).

In some embodiments, the NMPS includes a negotiation engine and a contract management engine. The negotiation engine can be operable to detect instructions that specify a list of contract terms open for negotiation between the buyer and the seller, to generate a user interface for the buyer and the seller. In some examples, the user interface includes a real-time discussion portion or panel and a contract term negotiation portion or panel that includes multiple contract review sections associated with the list of contract terms, to receive corresponding inputs from the buyer and the seller for each term of the list of contract terms through the contract term negotiation portion, and to detect a match condition between the corresponding inputs. The contract management engine can be operable to generate a contract for the buyer and the seller based on the list of contract terms after they have reached an agreement on all contract terms.

Consider an example scenario in which the NMPS facilitates a real estate sales transaction between a home buyer and a home seller. The example scenario includes three phases: a registration phase; a negotiation phase; and a closing phase.

In the first phase, the home seller launches a web browser installed on his desktop computer to access a website hosted by the NMPS (“the transaction website”). The home seller creates an account with the transaction website and submits information to list his home for sale (e.g., property information). The home buyer, either at the same time or at a later time, launches a web browser installed on her laptop to access the transaction website. The home buyer creates an account with the transaction website to start searching through one or more for-sale properties listed on the transaction website. Alternatively, the home buyer can start searching through the for-sale properties without creating an account; the account can be created later, e.g., at or during the negotiation phase and/or at or during the closing phase. The home buyer selects to view the seller's home listing on the transaction website, and further selects to request a live negotiation with the home seller. In some embodiments, the home buyer can submit, in the request for live negotiation, a suggested time and/or date to conduct the live negotiation. In some embodiments, the home buyer simply requests to start the live negotiation, for example, where the NMPS displays a notification that the home seller is “online” (e.g., currently logged into the transaction website).

In the next phase, a negotiation process can be initiated by the NMPS, in response to, for example, a home buyer's request. In one implementation, the NMPS sends the home seller a notification about a home buyer's request for live negotiation. If the home seller selects to accept the request for live negotiation, the NMPS provides for immediate or subsequent selection, a user interface to enable the negotiation to start. In one example, a component of the NMPS may determine a type of contract which may be appropriate for the negotiation being initiated. A component of the NMPS may also detect instructions which specify one or more contract terms that are associated with that type of contract. For example, a real-estate transaction may involve multiple, different contracts such as an Offer to Purchase Agreement, a Contract for Deed, a Lead-Based Paint Disclosure contract, and the like. In some embodiments, the NMPS further determines (e.g., based on the different contracts) the terms that are open for negotiation between the buyer and the seller. A user interface portion, such as provided through a negotiation panel, can indicate visually the terms that can be negotiated, or those terms which are deemed open for negotiation. In such embodiments, only the terms that are open for negotiation are associated with visual indicates or otherwise displayed through the negotiation panel.

In some embodiments, which terms are open for negotiation are configured by the seller and/or the buyer. In some embodiments, which terms are open for negotiation are configured by a system administrator. In some embodiments, which terms are open for negotiation are configured by a default setting associated with a particular contract type. Examples recognize that when the NMPS implements functionality e.g., document or content filter, to guide the parties to negotiate only negotiable terms , the completion of the online transaction is made more efficient in that the computational resources required for the negotiation are reduced by the time saved to limiting the the buyer and seller to discuss only pertinent matters. At the same time, examples judiciously guide the involved parties through steps of the transaction.

According to some examples, a negotiation engine of the NMPS operates to generate separate user interfaces (UI) for each party of the transaction based on the contract terms that are open for negotiation. The user interface for each party of the transaction can include a real-time discussion/negotiation panel and a contract term negotiation panel. The real-time discussion or negotiation panel can, for example, provide chat functionality to enable the buyer and the seller to discuss in real-time any issues and/or questions related to the real-estate sale.

The contract term panel can be a UI that includes multiple contract review sections for displaying the contract terms. Each review section can contain one contract term to enable the buyer and the seller to negotiate that term in real-time. For example, the home buyer can input a numerical value in the review section for the “price” term and the home seller can input another numerical value for that “price” term; the buyer and the seller can repeat the process until there is a match condition. The match condition can be, for example, two numerical values that are the same (e.g., $750,000 for sale price of the home).

According to some examples, the NMPS can include functionality for detecting when input provided by the parties of the transaction through the negotiation panel are sufficient to trigger an agreement event, termed a “match condition”. The match condition can result in a memorialization event with the contract term panel. In some examples, a contract (or contracts, or set of terms) provided through the contract term panel can be progressively accepted by buyer and seller, through coinciding real-time discussions made through the negotiation panel. The match condition, when detected, can progress agreement of a given contract. The match condition can be signaled under a variety of conditions which can appear dissimilar or not matched. For example, matched conditions can exist when the content of the communications include dissimilar terms or semantics or mismatched amounts.

Once there is a match condition detected for a particular term, the next review section is highlighted for the buyer and the seller (e.g., to bring to their attention the outstanding terms left to be negotiation). The highlighting can be accomplished by generating a visual indication. The visual indication can be embodied, for example, in a visually bolded outline of the next review section. In another example, the visual indication can be embodied as a green arrow pointing at the next review section (and/or the term in the next review section).

In some embodiments, the match condition can be configured by a system administrator or the buyer/seller themselves. For example, the buyer and the seller can specify that a match condition occurs if the inputs fall within a range (e.g., $5000 difference between $750,000 and $745,000). In this example, the buyer and the seller can further specify, or the NMPS can be configured to dictate, for that match condition that the final value for the “price” term is to be the half-way price-point (e.g., $745,000). Thus, the presence of the matched condition can occur when separate and dissimilar sub-events occur, specifically where each of buyer and seller specify dissimilar amounts which individually and/or collectively satisfy different conditions of amount. As an alternative or variation, the matched condition can be implemented by a rule that equates values, terms, semantics or wording of discussions (e.g., exchanged messages) that are dissimilar as being a matched condition. Once there is a match condition detected between the buyer's input and the seller's input for every single contract term, a contract is then generated automatically for the real estate transaction on behalf of the buyer and the seller.

As a next phase, some examples provide for a contract management engine to generate a contract (e.g., the purchase contract for the property) for a buyer and the seller based on the contract terms agreed upon in phase two. The contract management engine can also generate a timetable user interface that guides the seller and the buyer through the steps leading to the closing of the real estate transaction. The timetable user interface can include time segments that correspond to a timeframe. For example, ten time segments are generated to represent the ten days typically needed to complete various operations associated with a real-estate transaction (e.g., escrow, inspections, mortgage approval, transfer of title, etc.). The timetable user interface can also include a set of one or more tasks assigned to the buyer and/or the seller within each time segment. The seller and the buyer can each track and manage tasks that are to be completed for the real-estate sale. In some embodiments, the contract management engine can generate a set of alerts associated with the set of tasks to notify if the buyer and/or the seller of any incomplete task. Once the buyer and the seller have completed tasks identified by a timetable user interface, the contract management engine can provide the buyer and the seller each access to the final documents, including, for example, title, inspection documents, disclosure documents, agreements to amend/extend contract, the purchase/sales contract itself, and the like.

Among other benefits, the transaction management technology enables a buyer and a seller to complete an entire real estate transaction online, directly with each other without the use of an agent. Examples as described facilitate or enable negotiation of material terms required for closing a transaction, as well as generation of one or more contracts based on that negotiation, and the management of documents associated with the transaction. Examples further automate steps of separate phases for completing such transactions. For example, the NMPS can automate a second and third phase of a transaction for real-estate, in a manner that is seamless to a buyer or seller. Furthermore, according to some examples, buyers and sellers have access to documents, disclosures, negotiation, timeframe of a process, and coordination of a closing in a centralized place, thereby providing a guidance through all complexities of the sales transaction.

While the above and following description utilizes an example of a real estate transaction, in which a home buyer and a home seller are completing a sale of a home, for illustrative purposes only, to explain various aspects of the transaction management technology. However, examples as described are not limited in applicability to real estate transactions and home buyers/sellers, nor is it limited to the sales of residential real estate properties. Technology described with some examples can be utilized with numerous types of contract-based transactions, which under conventional approaches, require back-and-forth negotiations between individual persons for goods and/or services. Hence, the term “sales,” as in sales transactions, for example, refers to any type of transaction that necessitates negotiation, including, for example, automobile sales, asset purchases (e.g., antiques, rare valuable goods, etc.), construction project biddings, and is not limited to real estate purchases, or the like.

In examples described, the term “buyer” generally refers to a party making a payment in exchange for goods/services related to a transaction and the term “seller” generally refers to a party receiving the payment in exchange for the goods/services. On the other hand, the terms “consumer,” “customer,” or “user” refer generally to any party who utilizes the service offered by the negotiation and management platform.

The term “cause” and variations thereof, as used throughout this description, refers to either direct causation or indirect causation. For example, a computer system can “cause” an action by sending a message to a second computer system that commands, requests or prompts the second computer system to perform the action. Any number of intermediary devices may examine and/or relay the message during this process. In this regard, a device can “cause” an action even though it may not be known to the device whether the action will ultimately be executed or completed.

The term “detect” and variations thereof, as used throughout this description, refers to either active detection or passive detection. For example, a computer system can “detect” an instruction or a condition by passively receiving a message from a second computer system that notifies, commands, or delivers the instruction or condition to the computer system. In another example, a computer system can “detect” the instruction or the condition by actively searching for data stored in either the computer system or a second computer system.

Various examples of the transaction management technology will now be described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

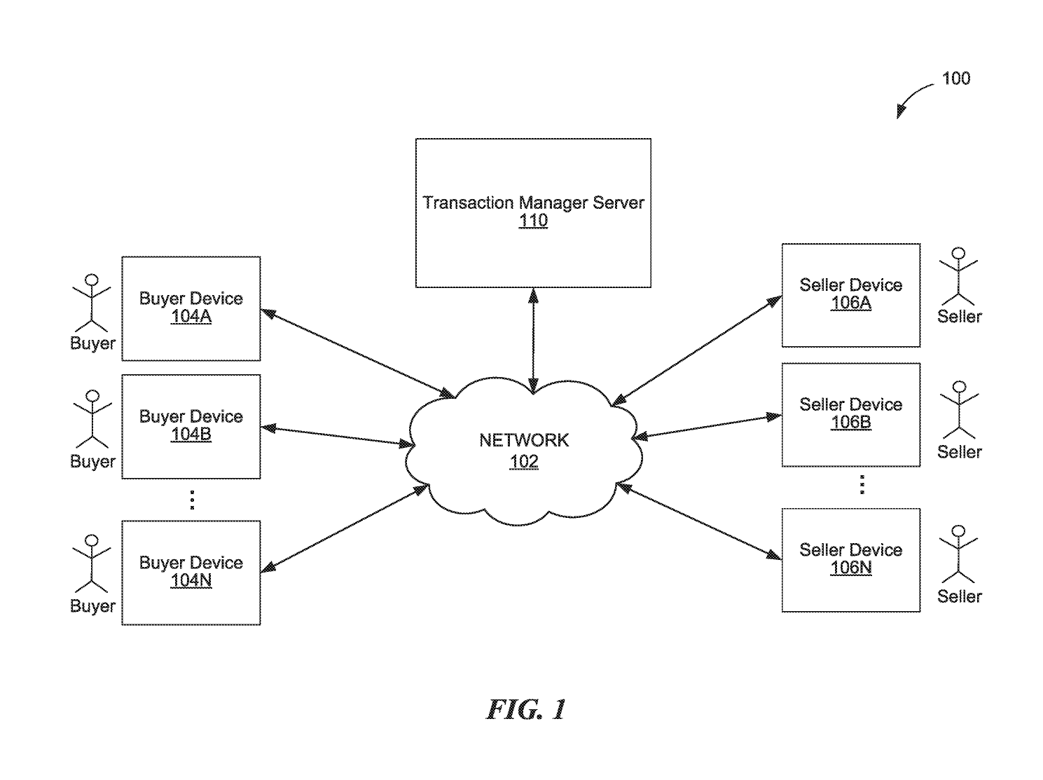

FIG. 1 depicts a diagram of a network-based environment 100 within which the transaction management technology can be implemented. The environment 100 includes a network 102, one or more buyers operating one or more buyer devices 104A-104N, one or more sellers operating one or more seller devices 106A-106N, and a transaction manager server 110 (“the server 110”). One of ordinary skill in the art will understand that the components of FIG. 1 are just one implementation of the network-based environment 100 within which present embodiments of the technology can be implemented, and various alternative embodiments are within the scope of the present embodiments.

The buyer devices 104A and the server 110 are coupled in communication for data transmission over the network 102. The seller devices 106A-106N are similarly coupled to the server 110 over the network 102. The network 102 can be a wired communications network or a wireless communications network (e.g., an IEEE 802.11 wireless network, or a data traffic network based on cellular telecommunication services such as 3G, 3.5G, 4G LTE and the like). The technologies supporting the communications between the server 110 and the buyer devices 104A-104N and the seller devices 106A-106N, respectively, can include Ethernet (e.g., as described in IEEE 802.3 family of standards) and/or other suitable types of area network technologies.

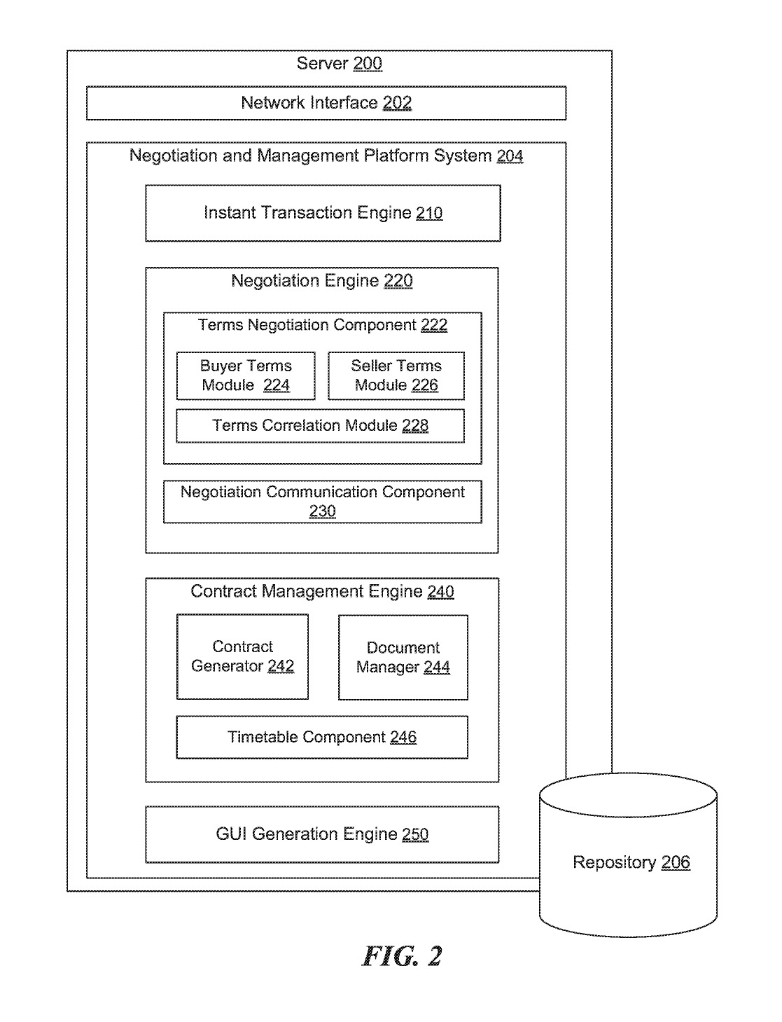

The server 110 can be one or more server computers or work stations that are employed by a transaction management service for hosting websites that function as a channel for customer users (e.g., buyers and sellers) to browse and/or list products (e.g., for-sale properties) and/or services, to conduct negotiations for one or more transactions, and to complete all operations of the transaction(s) directly with one another online. The server 110 typically includes at least one processor and a memory, and may be further connected to one or more computers (not shown in FIG. 1 for simplicity) that manage listings, documents, logistics, and/or other commercial functions via the network 102. The server 110 is also typically equipped with, or is coupled to, a repository (e.g., repository 206 of FIG. 2) for storing customer users' profiles, customer users' transaction criteria, specifications, and/or negotiation inputs, documents related to the transactions, and/or for hosting the website that facilitates the negotiation and management of the transactions.

Although the server 110 is illustrated in FIG. 1 (as well as described throughout the present disclosure) as a separate entity from the buyer device 104, it is noted that in some specific embodiments, the device 104 and the server 110 can be implemented in the same computing device, such as a smart phone or a tablet computer so that the standalone computing device can be the sole host of the environment 100 and practice the various embodiments disclosed here. The seller device 106 and the server 110 can be similarly implemented in the same computing device.

A buyer can use a particular buyer device 104 (e.g., the buyer device 104A) to access a negotiation and management platform system facilitated by the server 110 to negotiate a sales transaction with a seller. Similarly, the seller can use a particular seller device 106 (e.g., the seller device 106A) to negotiate with the buyer. Each of the buyer and seller devices 104, 106 can be, for example, a laptop, a desktop, a tablet, a desktop computer (e.g., a personal computer (PC)), a personal digital assistant (“PDA”), a smartphone, and the like.

Each of the buyer and seller devices 104, 106 typically includes a display that can be used to display one or more user interfaces, and can include suitable input devices (not shown for simplicity), such as a keyboard, a mouse, or a touchpad. In some embodiments, the display may be a touch-sensitive screen that includes input functionalities.

FIG. 2 is a block diagram of components of a server 200, in accordance with some embodiments of the transaction management technology. In some embodiments, the server 200 can be the server 110 of FIG. 1. The server 200 includes a network interface 202, a negotiation and management platform system 204, and a repository 206. In some embodiments, the negotiation and management platform system 204 (“NMPS 204”) includes an instant transaction engine 210, a negotiation engine 220, a contract management engine 240, and a graphical user interface (GUI) generation engine 250.

The network interface 202 can be a networking module that enables the server 200 to mediate data in a network between two or more remote computer systems that are external to the server 200, through any known and/or convenient communications protocol supported by the host and the remote computer systems. The network interface 202 can include one or more of a network adaptor card, a wireless network interface card (e.g., SMS interface, WiFi® interface, interfaces for various generations of mobile communication standards including but not limited to 1G, 2G, 3G, 3.5G, 4G, LTE, etc.), Bluetooth®, a router, an access point, a wireless router, a switch, a multilayer switch, a protocol converter, a gateway, a bridge, bridge router, a hub, a digital media receiver, and/or a repeater.

The repository 206 functions similarly to the repository discussed above with respect to FIG. 1. The repository 206 can be used for storing customer users' profiles, customer users' transaction criteria, specifications, and/or negotiation inputs, documents related to the transactions, and/or for hosting the websites that facilitate the negotiation and manage of the transactions. The repository can include, for example, one or more hard drives (which may be further coupled together using RAID-0, 1, 5, 10, etc.), a centralized or distributed data cluster, a cloud-storage service provider, or other suitable storage systems suitable for storing digital data.

According to some embodiments, the NMPS 204 includes the capabilities to provide a convenient and effective way to allow buyers and sellers to conduct online sales of one or more real-estate properties directly with one another, without use of an agent. During normal operations of the server 200, the GUI generation engine 250 works in coordination with the instant transaction engine 210, the negotiation engine 220, and/or the contract management engine 240 to generate one or more graphical user interfaces (GUIs), or user interfaces (UIs) or panels, representative of an online platform for the buyer and the seller to interact and engage in one or more operations (e.g., viewing, listing, or purchasing a property in a real estate sales transaction).

In some embodiments, the instant transaction engine 210 of the server 200 facilitates operations associated with an “instant-buy” transaction. In an instant-buy transaction, a seller of a property is provided the capability to specify or submit to the instant transaction engine 210, “instant-buy” terms for that property, where the instant-buy terms include all negotiated terms that are typical in a real estate sales contract. The instant-buy terms can include, for example, a purchase price, a deposit amount, a closing date, credits and/or repairs offered and appliances that stay with the home. In some embodiments, the instant transaction engine 210 generates suggested inputs for the terms based on data associated with other properties with comparable features and/or with other properties for sale in the same area as the seller's property. The seller can confirm, or accept, the suggested terms to have them be established as the instant-buy terms for the property.

Once the instant-buy terms are specified and/or confirmed by the seller, the instant transaction engine 210 causes the seller's property to be listed for interested buyers (e.g., via the transaction website). As a result, an interested buyer, when viewing the seller's property, is provided with an “instant-buy” option. In the event that the buyer selects the instant-buy option, and confirms that selection, a purchase contract, or real estate sales contract, is generated based on the instant-buy terms set by the seller. The instant transaction engine 210 can work in coordination with the contract management engine 240 to generate the real estate sales contract and manage operations for completion of that sales transaction.

In some embodiments, the negotiation engine 220 facilitates operations associated with an online negotiation process for a sales transaction. The negotiation engine 220 provides a buyer the capability to negotiate and to discuss with the seller the sale of a property in real-time. In some embodiments, the negotiation engine 220 includes a terms negotiation component 222 and a negotiation communication component 230. The negotiation communication component 230 facilitates operations that allow the buyer and the seller to communicate in real-time. The terms negotiation component 222 facilitates operations that coordinate corresponding terms received from the buyer and the seller for the negotiation of the property.

In some embodiments, the negotiation communication component 230 generates a dialog box that enables the buyer and the seller to discuss contract terms, answer and/or ask questions related to the property, and/or communicate any other concerns related to sales transaction of the property. In some embodiments, the negotiation communication component 230 generates one or more contract term review sections, where each section can be dedicated to a particular contract term of a list of contract terms to be negotiated between the buyer and the seller. In some embodiments, the contract term review sections are generated for display next to the dialog box to enable ease of use and convenience for the buyer and the seller as they discuss the terms.

In some embodiments, the terms negotiation component 222 includes a buyer terms module 224 and a seller terms module 226 for handling the negotiated terms from the buyer and the seller, respectively. The buyer terms module 224 is operable to receive alphanumerical input values from the buyer for each term of the contract. The seller terms module 226 is operable to receive alphanumerical input values from the seller for each term of the contract. More generally, each of the buyer terms module 224 and the seller terms module 226 can receive input and display output corresponding to the exchange of messages, conducted through a messaging protocol (e.g., for instant messaging). An example alphanumerical input value is a dollar amount (e.g., $1.2M for the “purchase price” term). Another example alphanumerical input value is a date (e.g., Nov. 11, 2014 for the “closing date” term.). Yet another example alphanumerical input value is a text description (e.g., “All kitchen appliances stay with house.”).

In some embodiments, the terms negotiation component 222 can also include a terms correlation module 228 that detects for one or more match conditions between the buyer and seller terms. The terms correlation module 228 works with the buyer terms module 224 and the seller terms module 226 to monitor the corresponding inputs received from the buyer and the seller, respectively. The terms correlation module 228 can parse the messages exchanged through the respective buyer terms module 224 and the seller terms module 226 in order to identify words, phrases, numerical values (including symbols such as ‘$’) which signify a negotiation of a material term. Upon detection of a match condition for any contract term, where the buyer's input matches the seller's input, the terms correlation module 228 records the input agreed upon for that term, and continues monitoring the remaining terms for a match condition. As used here, the match condition can be a correlation of data, and does not have to be an exact match. In some embodiments, the match condition is configured by a system administrator of the NMPS 204. In some embodiments, the match condition is configured by a buyer and/or a seller. In some examples, a match condition can be defined by a rule, such as specified by a seller, a buyer, and or an administrator. For example, the seller can specify a rule in which a match condition occurs, or is satisfied, if the difference between the seller's input and the buyer's input falls within a specified range (e.g., $1000 difference between purchase price inputs). In this example, the buyer can further specify, for that match condition, that the final input value for the term can be automatically set as the half-way value (e.g., $900,500 for values of 901,000 and 900,000). Thus, both seller and buyer can specify or define a rule for determining a match condition. In another example, the buyer, as opposed to the seller, can specify a match condition rule, such as provided by the range and the half-way value. Other examples of match conditions are possible for implementation of the transaction management technology in light of the disclosure herein.

In some embodiments, the occurrence of the match condition causes the terms correlation module 228 to identify a particular term that is agreed upon (or which the match condition relates to). The terms correlation module 228 can generate an indicator for display adjacent to a particular term to indicate agreement of that particular term between the buyer's input and the seller's input. The indicator can, for example, correspond to a green arrow next to the term. In this example, once the buyer and/or the seller sees the green arrow next to term, they each can move on to the next term (e.g., begin to negotiate a value for the next term in the list of contract terms). In some embodiments, the terms correlation module 228 continuously shifts the green arrow downward until all terms in the list of contract terms have been agreed upon between the buyer and the seller.

In some embodiments, the contract management engine 240 facilitates operations for generating sales contracts and managing documents and tasks associated with the sales contract. The contract management engine 240 includes a contract generator 242, a document manager 244, and a timetable component 246. The contract generator 242 is operable to receive the agreed negotiated terms from the negotiation engine 220 and to generate a sales contract based on those terms for the buyer and the seller. The buyer and the seller can each, for example, sign the sales contract to enter escrow. The GUI generation engine 250 can generate, for example, GUIs to prompt each of the buyer and the seller to review and execute the sales contract.

The document manager 244 is operable to manage all documents associated with the sales contract when the contract is executed by both the buyer and the seller. The documents can include, for example, any documents that need to be executed, or signed, and/or reports that need to be uploaded (e.g., pest inspection).

The timetable component 246 is operable to generate a timetable to assist the buyer and the seller in keeping track of all important deadlines associated with the timeframe accompanying the executed sales contract. The timeframe can extend, for example, for 10 days from the date of the contract signing to closing. In some embodiments, the timetable component 246 can work with the GUI generation module 250 to generate a grid-like table representative of the timeframe, where the grid-like table displays one or more tasks for one or more participants of the sales transaction. The participants can include, for example, the buyer, the seller, title, escrow, lender, and attorney.

In some embodiments, the timetable component 246 works with the GUI generation module 250 to generate and manage alerts associated with the tasks displayed in the grid-like table. In some embodiments, the timetable component 246 causes an alert, such as a reminder message, to be generated and sent to each participant in the sales transaction on a periodic basis. For example, each participant receives a daily email that denotes tasks for the participant for that day. In some embodiments, if one or more tasks are not completed on time (e.g., incomplete status on due date assigned to the task), the timetable component 246 causes another alert to be sent to the participant responsible for that task(s). In some embodiments, the alert is generated as a message within a GUI associated with the NMPS 204. In such embodiments, all participants accessing the NMPS 204, for example, can visually observe the late tasks and/or delinquent participants responsible for those late tasks.

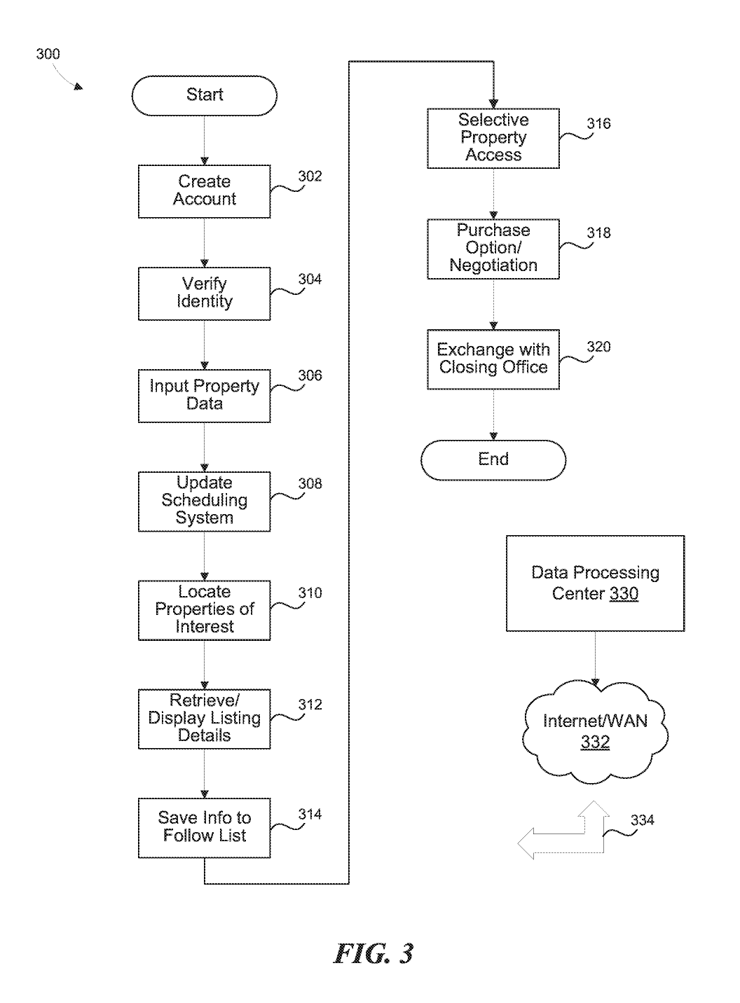

FIG. 3 is an example process (or workflow) for facilitating an online real-estate sales transaction 300 in accordance with some embodiments. In an example of FIG. 3, a transaction can be accomplished via a GUI to a data processing center 330 through a data network such as a wide-area network or Internet 332 (e.g., the network 102 of FIG. 1). The transaction can be completed via a web browser and internet connectivity 334. In some embodiments, the data processing center 330 is embodied as the transaction manager server 110 of FIG. 1.

An example process or work flow (represented as “transaction 300) starts at block 302 where the data processing center 330 creates an account for a user to access content delivered via the data processing center 330. For the account to be created, the user submits, for example, a username, a password, and identification information. In various embodiments, the account can be created for a buyer, a seller, or other interested party, or participant, of the transaction 300. With an account created, a user can login directly to a data system. In alternative embodiments, the user can login via a social media portal, such as Facebook® or Twitter®. In such embodiments, the user submits login credentials for the appropriate social media account, and upon verification of those login credentials with the corresponding social media server system, the data processing center 330 creates a user profile for the user.

At block 304, verification is made of the user, based on use of available confirmatory information from financial institutions, public records, third-party verification, or similar resources. In some embodiments, for a buyer user to create a profile, he/she is suitably informed that in order to schedule any showings or make an offer to purchase, his/her identity needs to be verified. In some embodiments, verification is accomplished through communication with a computer system employed by an approved lender. In some embodiments, verification is accomplished through communication with a computer system employed by an online identity verification company. Once verification has taken place, the buyer user will be able to make offers and schedule showings. In some embodiments, an identity of a seller user is not verified until a later time. For example, the seller user goes through the identity verification when the seller user lists a property for sale on the system.

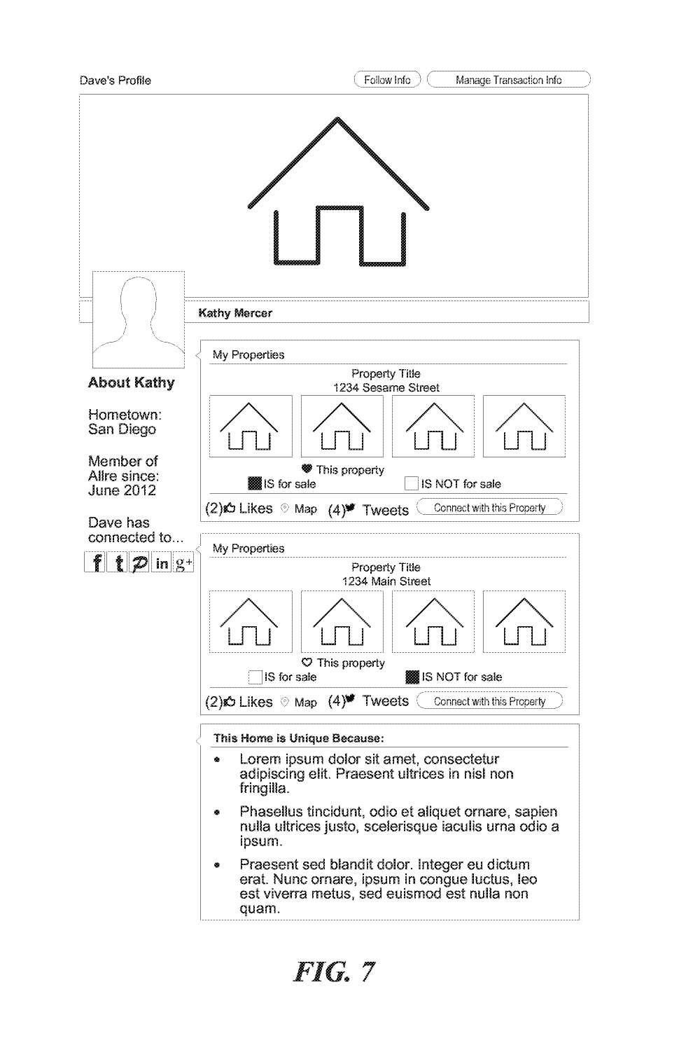

In some embodiments, both the buyer and seller have a public and private profile page. As used here, a “private profile” refers to a user profile that houses information about one or more properties a user owns, the user's login information, and the various social networks and online verification of identity prompts. As used here, a “public profile” refers to a user profile that shows information designated as public to other users on the website operated by the data processing center 330. From the public profile page, a user can message another user about a property they own. An example of a user profile is illustrated in FIG. 7.

At block 306, the seller submits to the data processing center 330 information about his/her property (“property information”). The seller can choose to list the home for sale or to simply connect the seller's user profile to the home and add the property information, but not put it for sale. Once the seller causes the property to be activated for sale (e.g., select “List Home for Sale” option), the seller has the ability to input as much or as little property information about their home as they wish. The property information can include property details, which may be imported from public records, pictures, videos, amenities, upgrades and a personalized showing calendar of when the property is available for a visit or open house.

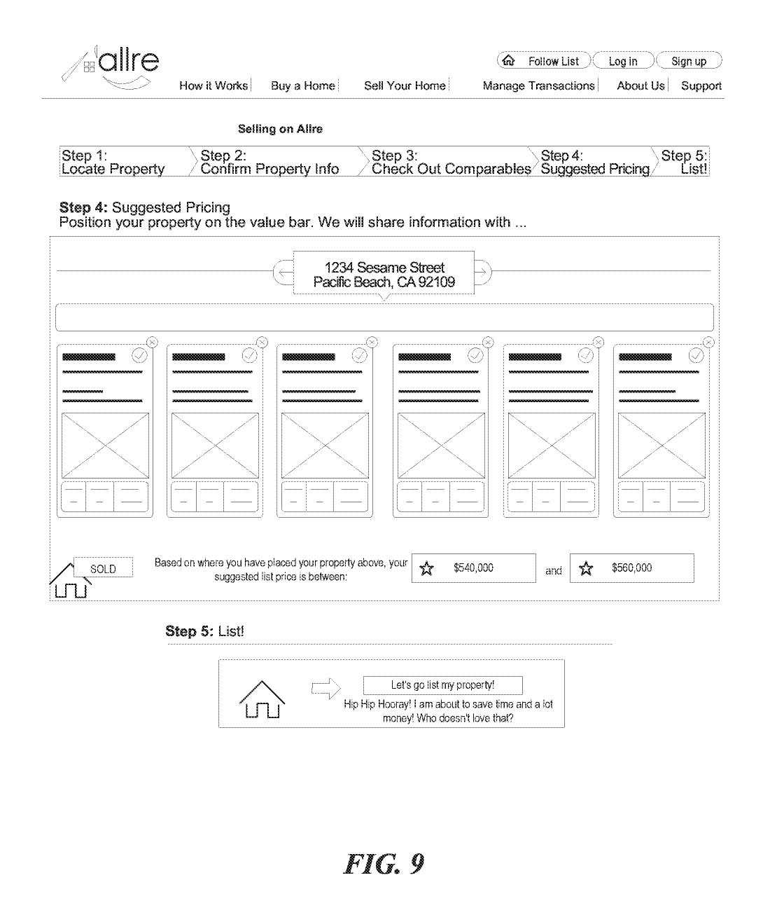

Some variations provide that at block 306, the seller can also input “instant-buy” terms, which can include all negotiated terms that happen in a real estate contract. As used here, the term “instant-buy” terms refers to the listing terms for the property, and serve as the terms that a buyer can agree to immediately to purchase the property right away without negotiation; that is, the terms make possible an instant buy of the seller's property (“instant-buy terms”). The instant-buy terms can include, for example, a purchase price, a deposit amount, a closing date, credits and/or repairs offered and appliances that stay with the home. In some embodiments, the data processing center 330 can provide suggested pricing for the sale of the property by providing the seller with property information on houses with comparable features or for sale in the area. An example of such a display is illustrated in FIG. 9. Note that the seller can continue to provide property information for any number of properties (i.e., not just one property) that the seller wishes to sell at block 306. The data processing center 330 can provide a GUI displaying all of the seller's properties that have been associated, or linked, to the seller's user profile. An example of such a GUI is shown in FIG. 7.

In some embodiments, the data processing center 330 provides a scheduling system, as indicated at block 308. The scheduling system provides the seller a capability to select the time slots that the seller's property is available for showing show and/or the times the property will be open for an open house. The selected times selected, or inputted, by the seller are then translated onto a master calendar that any interested buyer can see and schedule accordingly. In some embodiments, all of the available time slots for showings are kept on one master calendar for both the buyer and seller to access. In such embodiments, the buyer, for example, can make a showing request during a time slot that the seller has inputted an open spot, and the seller has the option to accept, reject, or request a re-schedule of the buyer's request.

At block 310, an interested buyer accesses the website and searches for properties he/she is interested in viewing or buying. In some embodiments, the data processing center 330 generates a search webpage for the buyer to input search criteria. The data processing center 330, upon receiving the search criteria, can return a list of one or more properties to the buyer. In some embodiments, the list of properties are shown on a map. In some embodiments, the list of properties are shown in a list view along with the map, where the details of the property are populated, e.g., on the right side of the webpage as the buyer clicks on the map markers or listings in the list view.

At block 312, the data processing center 330 retrieves listing details. In some embodiments, the data processing center 330 can display the listing details in a GUI for a user. For example, when a buyer user selects to view a listed property that is listed by a seller, the data processing center 330 displays the listing details, which can include, for example, Photos, Maps, Description, Local Schools, Neighborhood Information, Qualify with a lender for this house, Schedule a visit, Buy the property.

At block 314, the buyer user is provided a capability to store the listing information for a particular property (e.g., a property that the buyer user is interested in). In some embodiments, the buyer user can store the listing information to a “follow” list. The buyer user can, for example, use or retrieve the listing information for that property later from the follow list. In some embodiments, the buyer user can also schedule a viewing or proceed toward a purchase of the property. They can schedule a visit or make an offer without “following” the property (i.e., add the property to the follow list). If they schedule a showing or make an offer, the property is automatically placed in their follow list.

At block 316, the seller user can choose to grant access to the property in multiple ways. By way of example, these multiple ways include:

Meeting the buyer, optionally with scheduling of the same;

Telling a buyer where a hidden key is located;

Giving the buyer a code to a stationary lockbox; or

Giving the buyer access to a smart lockbox that the seller has purchased through the website.

Additionally, the seller user can provide other special instructions to the buyer user in ways other those listed above. On the other hand, the buyer user can choose which property he/she would like to make an offer by selection of one of several options.

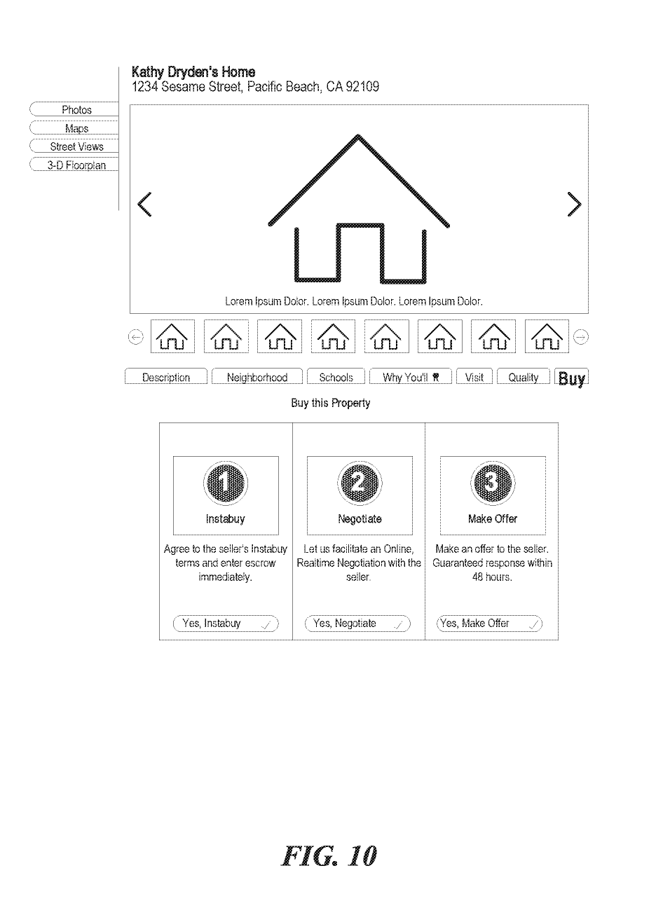

At block 318, the buyer user selects an option to proceed, which include an option to make an offer of purchase and/or an option for negotiation. See, by way of example, FIG. 10. In some embodiments, the buyer user is able to make an instant purchase of the property if the seller user has selected the option to list his/her property for “instant-buy” which includes instant-buy terms for immediate purchase, where the instant-buy terms operate as pre-agreed terms at which the seller user is willing to sell the property upon acceptance by the buyer user. In such embodiments, if the buyer user accepts the instant-buy terms associated with the property, the buyer user can simply accept the terms (e.g., via an acceptance click). Upon submitting the acceptance of the terms, e.g., to the data processing center 330, the buyer user is directed to a contract that is automatically generated in response to acceptance of the instant-buy terms. The buyer user can proceed by signing the contract, which would open escrow on the property.

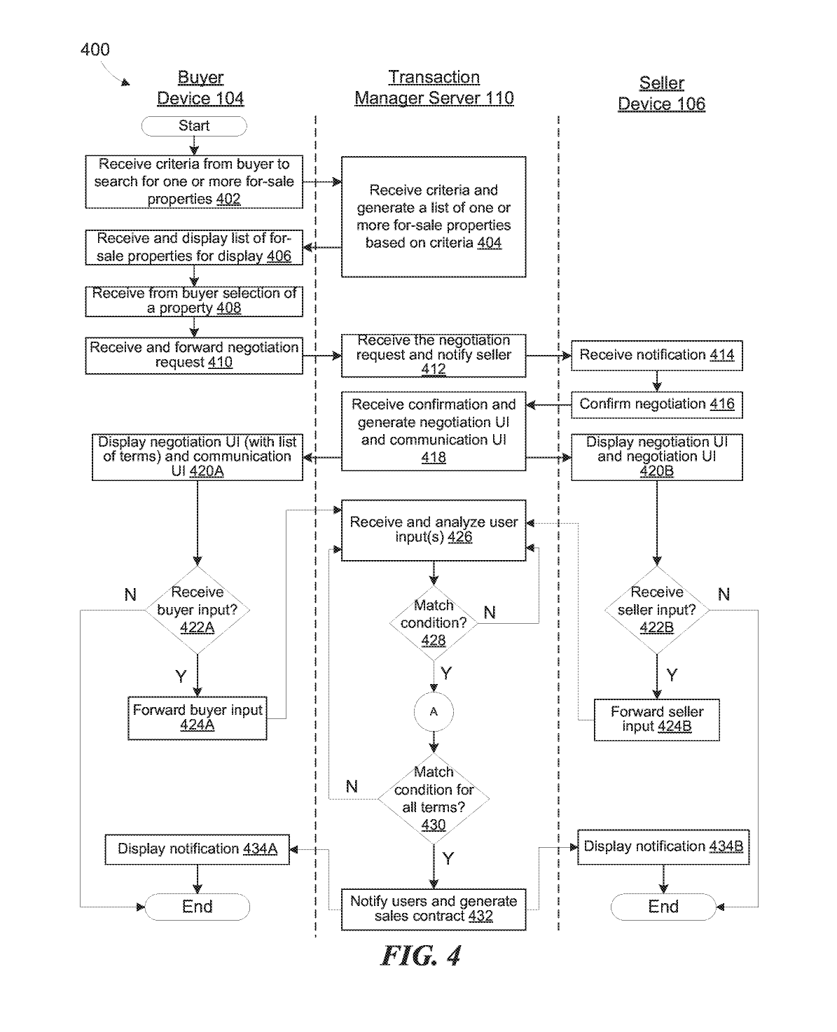

In some embodiments, the buyer seller is provided an option to engage in a live negotiation process that occurs online (e.g., via the NMPS 204 of FIG. 4). In such embodiments, the buyer user and the seller user can agree on a time to real-time chat and negotiate their deal to purchase the property. In some embodiments, the seller's terms for instant purchase are displayed as a starting point for the negotiation. In some embodiments, additional categories outlining what to discuss in the chat are also generated and displayed for the buyer user and the seller user. For example, once the buyer user and the seller user agree on a term via a chat panel, they both input those terms into the negotiation panel. When they match, the data processing center 330 gives them a green arrow to move onto the next item. Once all of the items have been negotiated, the buyer user and the seller user are both sent to the contract, which is pre-filled with their appropriate terms and prompted to sign the contract and enter escrow. Additional details regarding the negotiation process is discussed below with respect to FIG. 4.

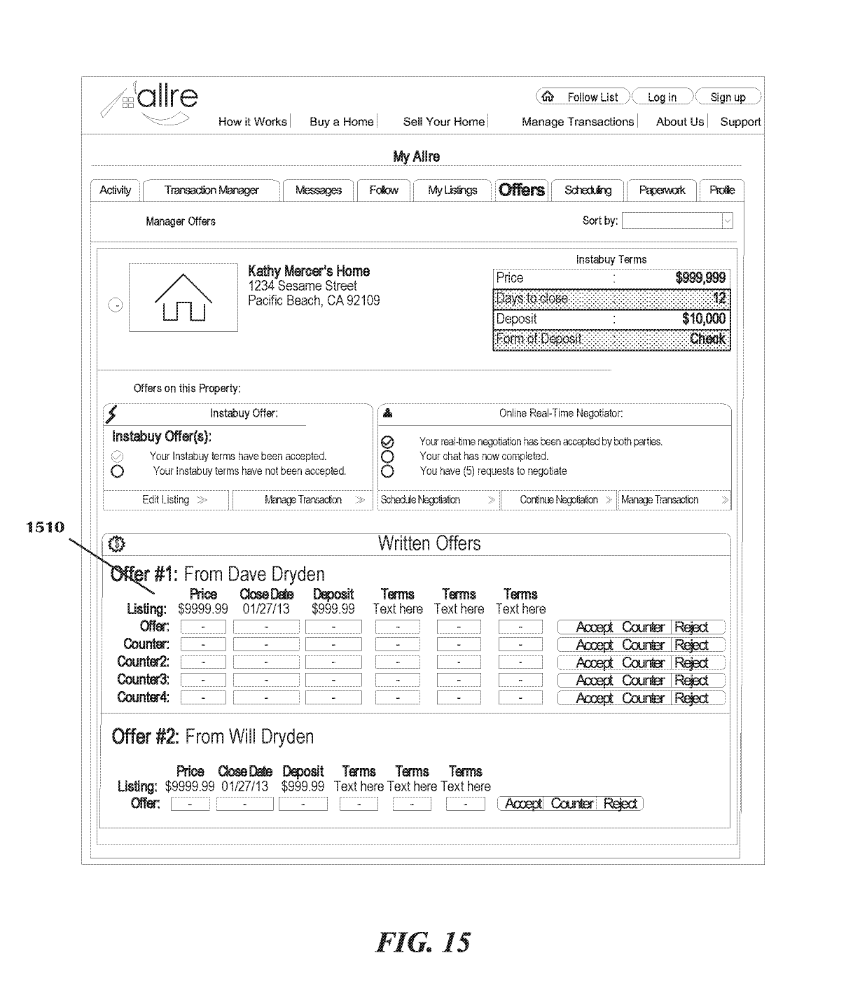

In some embodiments, buyers are provided with a capability to submit an offer for the purchase of the property, unlike the live negotiation process as discussed previously. In such embodiments, one or more buyer users are provided a simple form to fill out with the negotiable terms. The seller user can counter, reject, or accept an offer, as illustrated in FIG. 15. Once it is accepted, the contract is automatically filled out by and buyer and seller are prompted to sign and escrow is opened.

In some embodiments, the data processing center 330 sends the contract and transaction information to a suitable closing office who logs into a custom built backend system and assigns the file to a closing office within 30 miles or 30 minutes of the property.

In some embodiments, the entire sales transaction is then advantageously projected against a timeframe, such as a 10 day timeframe for closing. The participating parties, such as Buyer, Seller, Title, Escrow, Lender and Attorney, all have a column on the chart detailing their tasks on a daily basis. In some embodiments, each party, or participant, in the transaction is sent a periodic reminder, such as a daily email with denoting tasks for the day. If tasks are not completed on time, the subject system will advantageously facilitates send another email and/or a text message reminder.

In some embodiments, the data processing center 330 facilitates easy viewing of summary information with a snapshot everything that is going on with their listings, potential purchases and transactions.

Advantageously, the data processing center 330 suitably enables required documentation, such as that needing to be signed as well as reports that need be uploaded into the file, to occur at a backend location. Therefore, on the user side, the user sees the tasks displayed specifically for them and can also see the tasks displayed for each party in order to create an advantageous system of checks and balances.

Once all tasks have been completed, the transaction is able to close escrow. In some embodiments, the closing is reported to the data processing center 330 by a closing office, as indicated in block 320. In such embodiments, the data processing center 330 stores the associated file for selected period, such as a period of seven years, e.g., to allow users to go back and access as needed.

FIG. 4 illustrates an example process 400 for facilitating a negotiation between a buyer and a seller in a real-estate sales transaction, in accordance with some embodiments. In some embodiments, the server 110 of FIG. 1 executes the process 400. In such embodiments, various components of the server 110 work in coordination to execute the different steps and/or blocks of the process 400. In some embodiments, these components can be the components of the server 200 discussed in FIG. 2. Note that while the process 400 is executed for a real-estate sales transactions in accordance with some embodiments, in other embodiments, the process 400 can be executed for other types of sales transactions, such as an automobile sales transaction.

For purposes of illustration only, the process 400 of FIG. 4 is explained below with reference to some components illustrated in FIG. 1. The process 400 starts at block 402 when a buyer, using the buyer device 104, launches website implemented by the transaction manager server 110, and inputs, or submits, one or more criteria to search for one or more properties that are for-sale (e.g., listed on the website). In some embodiments, the buyer first creates an account with the website before submitting the search criteria (e.g., as discussed in block 302 of FIG. 3). In some embodiments, the buyer logins to an account already created. In some embodiments, the buyer simply begins searching for properties without creating and/or login to an account.

At block 404, the transaction manager server 110 receives the criteria from the buyer device 104. The transaction manager server 110, in response, determines one or more for-sale properties that match the criteria and generates a list of those properties for the buyer, as indicated by block 404. At block 406, the buyer device 104 receives the list of properties from the transaction manager server 110 and displays them to the buyer.

At block 408, the buyer selects a particular property from a list of one or more properties generated by the transaction manager server 110. The buyer can view listing details about the property upon selection. In some embodiments, the buyer is presented with one or more options to act upon the property, including an option to make an offer for purchase, an option to request a live negotiation with the seller, and an option to make an instant buy of the property. In accordance with the embodiments of FIG. 4, the buyer selects the option to request the live negotiation, and the buyer device 104 forwards the negotiation request to the transaction manager server 110, as indicated by block 410. In some embodiments, the buyer can also select a date and a time for the negotiation when request the live negotiation with the seller. In such embodiments, the date and the time are included in the negotiation request forwarded to the transaction manager 110.

At block 412, the transaction manager server 110 receives the negotiation request from the buyer and notifies the seller. In some embodiments, the transaction manager server 110 notifies the seller by generating a notification for delivery to an inbox associated with the seller's user profile on the website (e.g., transaction website executed by the transaction manager server 110). The seller can receive the notification through the website's inbox using the seller device 106. In some embodiments, the transaction manager server 110 notifies the seller by generating an email message for sending to the seller at an email address registered with the seller's account. In such embodiments, the seller, using the seller device 106, can receive the notification through an email application installed on the seller device 106. In some embodiments, the transaction manager server 110 notifies the seller by generating a text message for sending to the seller at a telephone number registered with the seller's account. In such embodiments, the seller can receive the notification through a text messaging application using the seller device 106.

At block 416, the seller confirms to accept the negotiation request from the buyer. In some embodiments, the seller can input a proposed date and time for negotiation that is different from the one requested by the buyer. In some embodiments, the seller simply inputs the proposed date to indicate when the seller is available for the live negotiation, where the buyer has not inputted a date and time in the negotiation request.

At block 418, the transaction manager server 110 receives the confirmation from the seller submitted via the seller device 106, and generates a GUI, for display at the buyer device 104 and the seller device 106, respectively, to facilitate the negotiation. In generating the GUI for the live negotiation, the transaction manager server 110 generates a negotiation UI and a communication UI for inclusion in the GUI. The transaction manager server 110 causes the devices 104, 106 to display the negotiation UI and the communication UI to the buyer and the seller, respectively, as indicated by blocks 420A and 4208. As described with various examples, the negotiation UI can be implemented through an interactive panel.

The negotiation UI is the contract term negotiation portion of the GUI that allows the buyer and the seller to submit alternatives for negotiation of each term in a list of contract terms for the sales contract to be finalized. In some embodiments, to generate the negotiation UI, the transaction manager server 110 first determines the type of contract appropriate for the negotiation being initiated. For example, based on the event that the buyer and the seller are negotiating the sale of a home with ordinary conditions (i.e., no extraneous, special circumstances), the transaction manager server 110 determines that a standard offer-for-purchase contract is needed, and in response, detects for the instructions specific to that type of contract. The instructions can specify to the transaction manager server 110 all of the contract terms that are associated with that type of contract, and in particular, specify those contract terms that are open for negotiation for that type of contract. In some embodiments, the transaction manager server 110 detects the instructions by receiving them from a remote computer system (e.g., a real-estate contract data center employed by a real-estate service company, an automobile contract data center employed by an automobile service company, etc.). In some embodiments, the transaction manager server 110 detects the instructions by accessing a database (e.g., repository 206 of FIG. 2) to obtain stored instructions specifying a list of contract terms associated with the contract at issue.

In some embodiments, the list of contract terms can include a list of default contract terms. In some embodiments, the list of contract terms can include one or more contract terms specified by the seller. In some embodiments, the instructions specifying the list of contract terms include instructions specifying predetermined values for the terms. For example, where the seller has specified values for the list of contract terms to be used in an instant-buy transaction, those specified values can be loaded into the negotiation UI as the values to start the negotiation with the buyer. More details regarding the negotiation UI are discussed below.

In some embodiments, the negotiation UI includes multiple contract term review sections for reviewing all terms of the list of contract terms. The number of review sections correspond to the number of contract terms in the list of contract terms, where each review section displays each term of the list of terms for review by the buyer and the seller at their respective devices 104, 106. In some embodiments, each of the review sections includes two separate columns to allow the buyer and the seller to submit their respective inputs for the term. For example, a review section for the purchase price includes a first column for the buyer to submit his proposed price to the seller and a second column for the seller to counter with his desired price.

The communication GUI is the live discussion portion of the GUI that allows the buyer and the seller to discuss with each other about the list contract terms. In some embodiments, the communication UI includes a dialog box that enables the buyer and the seller to communicate. For example, the buyer can start chatting with the seller through the dialog box.

Referring back to the process 400, at block 422A, the buyer device 104 determines whether a buyer input for a particular contract term is received from the buyer via the negotiation UI (e.g., via a particular contract term review section of the negotiation UI). If a buyer input is received, the buyer device 104 forwards that input to the transaction manager server 110 (e.g., via the web browser communicating to the server 110), as indicated by block 424A. At block 422B, the seller device 104 determines whether a seller input is received from the seller for the same contract term via the negotiation UI. If a seller input is received, the seller device 106 forwards that input to the transaction manager server 110 (e.g., via the web browser communicating to the server 110), as indicated by block 424B.

At block 426, the transaction manager server 110 receives the buyer and seller inputs from the buyer device 104 and the seller device 106, respectively. At block 428, the transaction manager server 110 further analyzes the buyer input with the seller input for the particular contract term to detect a match condition between the inputs. If the match condition does not occur (i.e., the seller and the buyer inputs do not satisfy the match condition), the process 400 returns to block 426 to await for additional corresponding inputs from the buyer and the seller. For example, the buyer sees the seller input and decides to submit a different input as a counter offer. In this example, the new buyer input is received or detected by the transaction manager server 110, which then determines if the match condition for that particular contract term has occurred based on the new buyer input.

If the seller and the buyer inputs do satisfy the match condition, the process 400 continues to block 430 to monitor for any additional match conditions for the remaining contract terms. In particular, the transaction manager server 110 determines whether there has been a match condition detected (e.g., block 428) for all of the contract terms in the list of contract terms for the sales transaction. If there is a match condition for every single contract term, the process 400 proceeds to block 432.

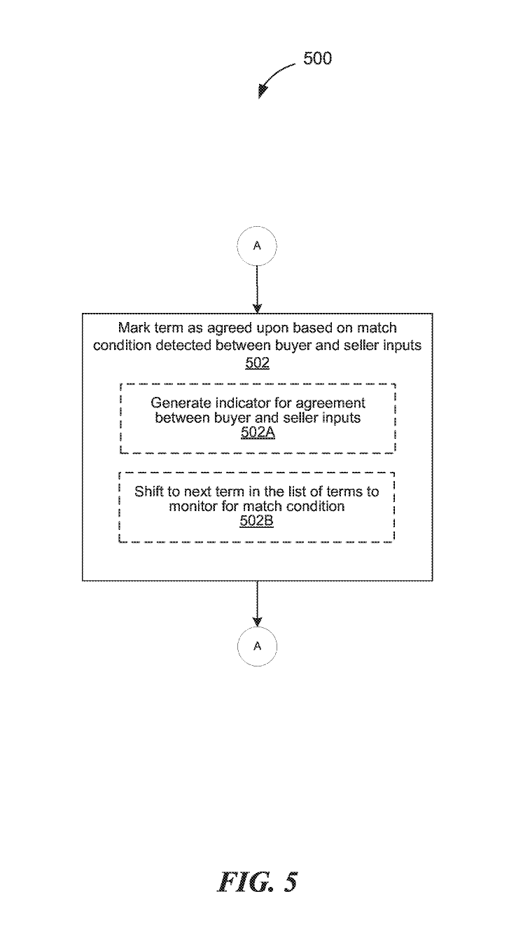

In some embodiments, when the transaction manager server 110 detects one or more match conditions at block 428, the transaction manager server 110 performs additional operations (“A”) associated with the detected match condition(s) in accordance with various embodiments. These operations are discussed below in reference to FIG. 5.

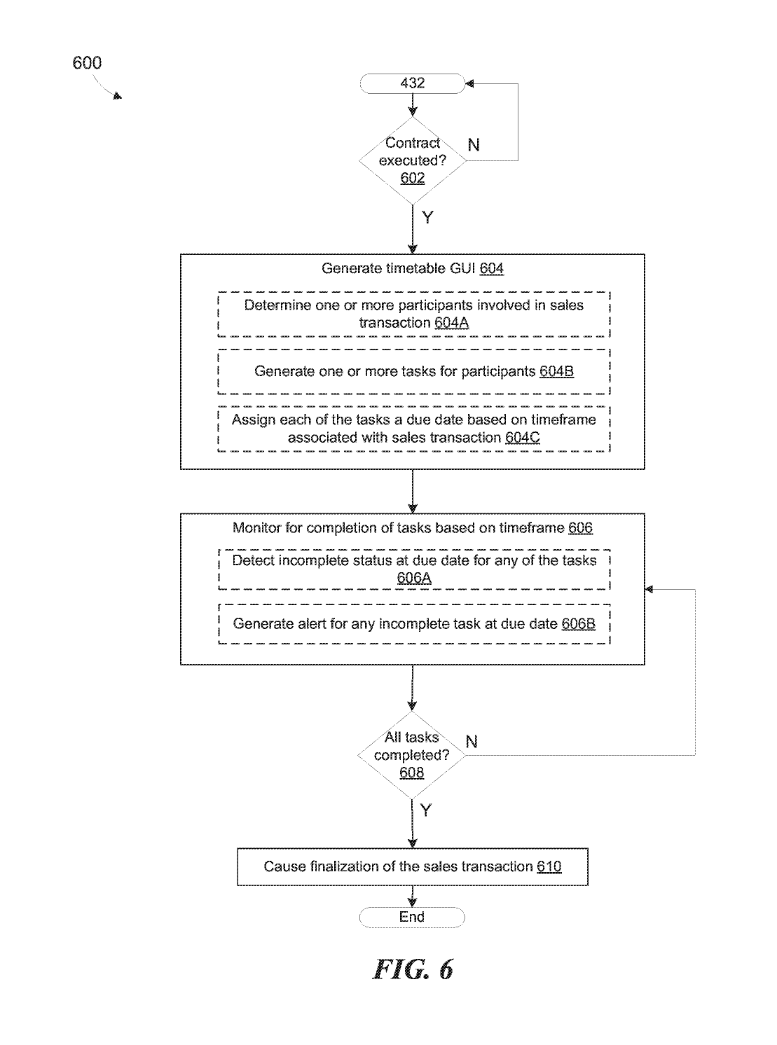

Referring back to block 432, the transaction manager server 110 notifies the buyer and the seller of a successful negotiation, i.e., that all terms are agreed upon between the buyer and the seller. In some embodiments, at block 432, the transaction manager server 110 further generates a sales contract automatically upon detecting a match condition for each of the terms. Additional details regarding block 432 are discussed in process 600 of FIG. 6.

At block 434A, in response to the notification from the transaction manager server 110, the buyer device 104 is caused to display the notification of a successful negotiation to the buyer. Similarly, at block 434B, the seller device 106 is caused to display the notification of the successful negotiation to the seller. In some embodiments, the successful negotiation notification includes a sales contract generated based on the negotiated terms between the buyer and the seller.

FIG. 5 is a flowchart illustrating an example process 500 for performing additional operations associated with block 428 in which a match condition between the buyer and seller inputs is detected, in accordance with various embodiments. In some embodiments, the process 500 can be executed by the server 110 of FIG. 1.

At block 502, upon detecting a match condition between the buyer and seller inputs for a particular contract term, the server 110 marks the particular contract term to indicate that agreement has been reached between the buyer and the seller for that term. In some embodiments, the server 110 marks the particular contract term by generating an indicator, as indicated by block 502A. The indicator can be generated to be visually displayed to the user, e.g., via a GUI. In some embodiments, the indicator is visually displayed next to the term to visually mark the term for the buyer and the seller who are viewing at their respective devices 104, 106. For example, the indicator is a green light that appears next to the term when agreement is reached (e.g., match condition occurs). In some embodiments, the indicator is visually embodied in a formatting of text. For example, the indicator is a bolding of text that bolds the text of the term to indicate agreement (e.g., “Price”), while the text of the outstanding contract terms remain visually displayed as regular text.

In some embodiments, the server 110 marks the particular contract term by causing the indicator to shift to the next contract term of the list of contract terms (where there is not yet an agreement), as indicated by block 502B. For example, the indicator can be an arrow that is caused to shift downward. In another example, the indicator can be a highlighting that is caused to highlight the next review section, of multiple review sections, that includes the next contract term that needs negotiation.

FIG. 6 is a flowchart illustrating an example process 600 for finalizing the sales transaction in accordance with some embodiments. In some embodiments, the process 600 can take place after block 432. The process 600 can be executed by the server 110 in accordance with some embodiments. The process 600 starts at block 602 where the server 110 determines whether the sales contract has been executed, or signed, by both the seller and the buyer. Execution of the contract can be determined, for example, by the server 110 receiving an electronic signature from the buyer and the seller, respectively. In another example, execution of the contract can be determined by the server 110 receiving a paper document scanned into a database of the server 110 (e.g., repository 206 of FIG. 2), where the paper document is the executed contract. If the server 110 determines the sales contract has not been executed, the process 600 repeats.

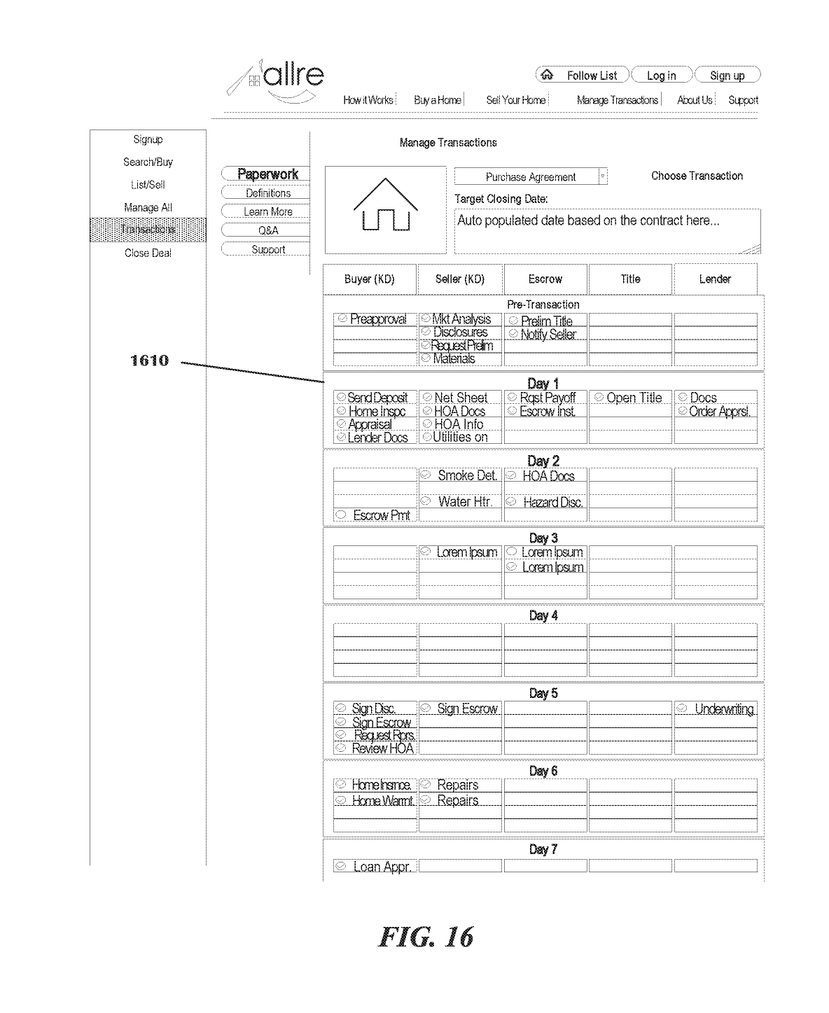

When the server 110 determines the sales contract has been executed, the process 600 continues to block 604. At block 604, the server 110 generates a timetable GUI based on the contract, where the timetable GUI includes a timeframe that corresponds to time sections associated with the sales transaction agreed upon in the contract. For example, the timeframe can be a 10-day timeframe representative of the range between the signing of the contract and closing, where the timeframe is divided into 10 different sections for the 10 days. An example of the timetable GUI is shown in FIG. 16.

In some embodiments, the server 110 generates the timetable GUI by determining all of the participants involved in the sales transaction, as indicated by block 604A. The server 110 can determine the participants for a particular sales transaction by accessing a database for stored information relating to participants associated with the sales transaction. For example, the involved participants associated with a real estate sales transaction include a buyer, a seller, title service, escrow service, a lender, and an attorney.

In some embodiments, the server 110 further generates one or more tasks to be assigned to the participants in generation of the timetable GUI, as indicated by block 604B. In such embodiments, the tasks can be distributed among the participants, where a particular task is assigned to a corresponding participant responsible for that task. In some embodiments, the server 110 further assigns each task to a particular due date based on the timeframe associated with the sales transaction. The due date defines when the task is scheduled or targeted to be completed by a user, such as a buyer, (e.g., a targeted completion date/time).

At block 606, the server 110 monitors for completion of one or more tasks included in the timetable GUI based on the timeframe. In some embodiments, in monitoring the tasks, the server 110 detects for an incomplete status of any of the tasks at a due date associated with that task, as indicated by block 606A. In some embodiments, the server 110 generates an alert for any task that is detected to be incomplete at its due date, as indicated by block 606B.

For example, consider a task of “Check smoke detectors” where the due date assigned to the task is Day 2 and the task is assigned to the seller. Upon a passing of Day 2 (e.g., passage of time from Day 2 to Day 3), the server 110 determines whether the task is still incomplete (i.e., incomplete status). If the task is incomplete, the server 110 marks the task as “overdue.” Further, the server 110 generates an alert to be displayed in the timetable GUI for viewing by all participants. This can be helpful, for example, for the remaining participants to remind the seller to complete the task. In some embodiments, the server 110 generates the alert in the form of an email message sent to the seller as a reminder to complete the task. In some embodiments, the server 110 compiles one or more alerts associated with tasks assigned to a particular participant (e.g., to the seller) and sends a summary email to that participant based on a specified time (e.g., daily, every two days, etc.). In some embodiments, the server 110 compiles one or more alerts associated with all of the tasks and sends a summary email to all participants, e.g., to inform all participants of outstanding, overdue tasks and completed tasks.

At block 608, the server 110 determines whether identifies tasks are completed. If the identified tasks are not completed, the server 110 continues monitoring (e.g., block 606). If all tasks are completed, the server 110 continues to block 610 to cause finalization of the sales transaction. In some embodiments, to cause finalization of the sales transaction, the server 110 communicates with a remote server employed by an escrow company to close escrow. The escrow company can report the closing to the server 110. In some embodiments, the server 110 stores all files associated with the sales transaction for a selected period of time (e.g., a period of seven years). This is advantageous in that it allow the participants in the sales transaction to access the files whenever needed.

Regarding the processes 300, 400, 500, and 600, note that while the processes and/or methods introduced include a number of operations that are discussed and/or depicted as performed in a specific order, these processes and/or methods can include more or fewer operations, which can be performed in serial or in parallel. An order of two or more operations may be changed, performance of two or more operations may overlap, and two or more operations may be combined into a single operation.

FIGS. 7-18 show examples of various screen displays that can be generated by the transaction manager server and loaded onto a user device (e.g., downloaded via a mobile transaction application or accessed via a web browser application installed on the user device). The user device can be the buyer device 104 or the seller device 106.

FIG. 7 shows an example of a screen display for a user profile according to some embodiments. The user profile illustrated in FIG. 7 includes information for a user “Kathy Mercer” who has connected, or associated, her user profile with two properties, where one is for available for sale and one is not available for sale. An interested buyer can view Kathy Mercer's user profile to view any property connected to her user profile, and even, for example, add a property to the interested buyer's follow list (e.g., select a heart-shaped icon next to the property).

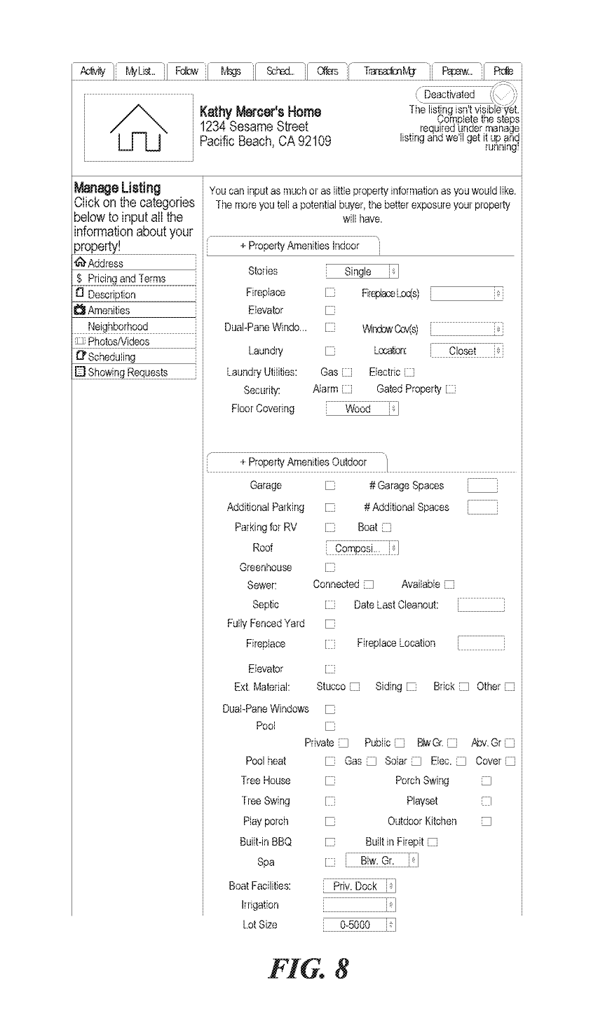

FIG. 8 shows an example of a screen display for a property information landing page, A seller, for example, can input detailed information about her property at the property information landing page, including, for example, property amenities.

FIG. 9 shows an example of a screen display for showing a user information related to comparable homes. The comparable homes are properties that have comparable features as another property being viewed by a seller, and/or properties that are for sale in the same area as the property being viewed. The comparable homes can be generated by the server 110 to enable the seller a better understanding of properties that are currently on the market. The seller can adjust, for example, the selling price of the seller's property by looking at the comparable homes.

FIG. 10 shows an example of a screen display for options provided to an interested buyer for a particular property listed for sale, according to some examples. As illustrated, the options include an “Instabuy” option, a “Negotiate” option, and a “Make Offer” option. With the Instabuy option, the interested buyer can make an instant buy, or purchase, of the property, where the terms are already pre-set or designated by the seller and selection of the option enables the buyer to accept those terms (and purchase the property) without any further negotiation necessary. With the Negotiation option, the interested buyer can initiate, or start, a live negotiation with the seller. For example, upon selection of the Negotiation option, the buyer can input suggested date/time to conduct the live negotiation. In this example, once the seller accepts the date/time (or propose alternative date/time that works for the buyer), the live negotiation is initiated. With the Make Offer option, the buyer can carry out the negotiation with the seller, but without the benefit of having a “live” negotiation. That is, the seller and the buyer are to exchange messages over a period of time, as opposed to being able to communicate, or discuss, issues in real-time.

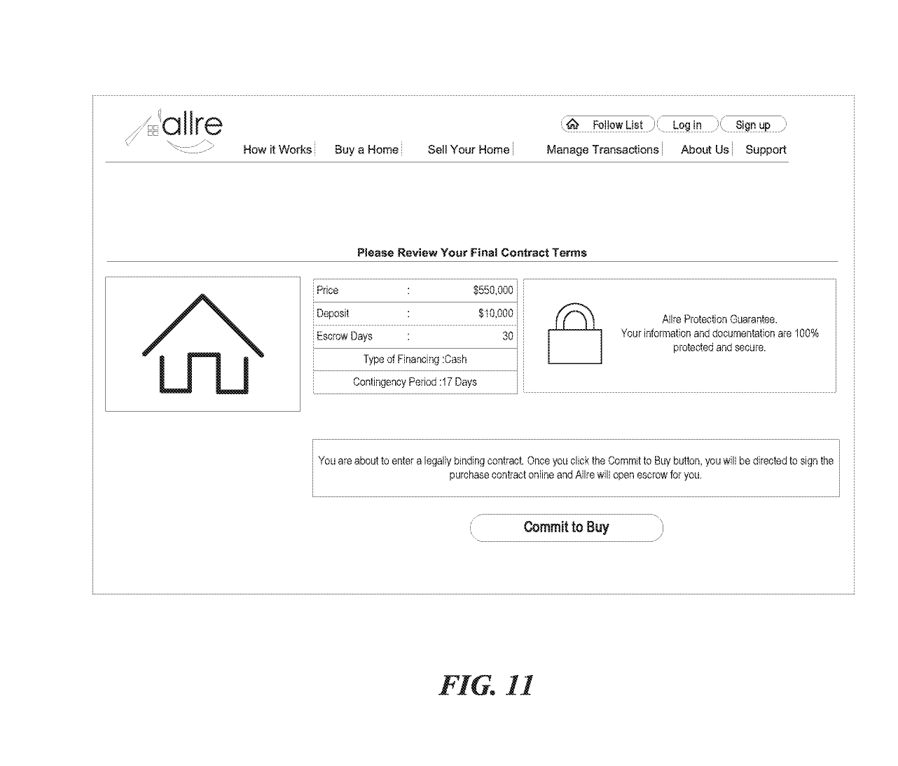

FIG. 11 shows an example of a screen display for an instant purchase confirmation display. For example, when an interested buyer selects the Instabuy option illustrated in FIG. 10, the instant purchase confirmation display is generated to inform the buyer that an instant transaction will be executed upon the buyer's confirmation (e.g., by clicking “Commit to Buy”).

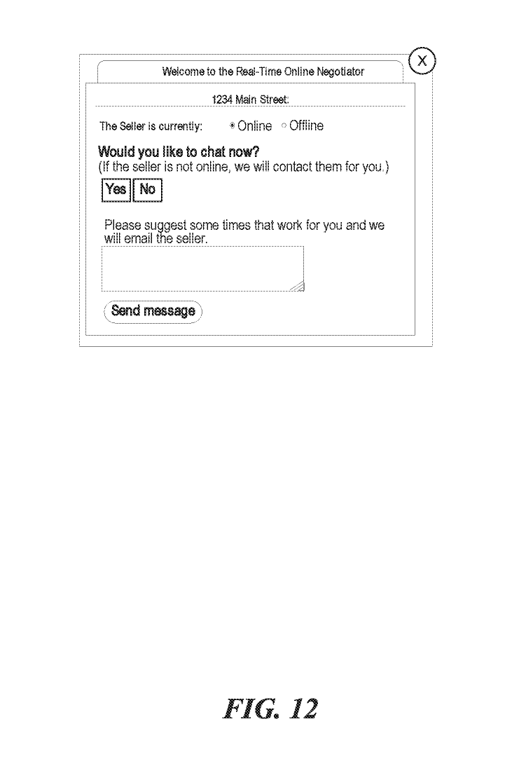

FIG. 12 shows an example of a screen display for confirming a live negotiation request. The screen display illustrated in FIG. 12 can be generated in response to an interested buyer selecting the Negotiation option illustrated in FIG. 10. The screen display illustrated in FIG. 12 informs the interested buyer whether the buyer is currently online. In some embodiments, the screen display can also include an input field to enable to the buyer to submit a date/time to schedule the live negotiation with the seller. For example, the buyer can input a specific date and/or time to discuss in real-time (e.g., chat) with the seller and to negotiate the terms for purchase of the seller's property. In some embodiments, the screen display can generate suggested time/date to schedule the live negotiation.

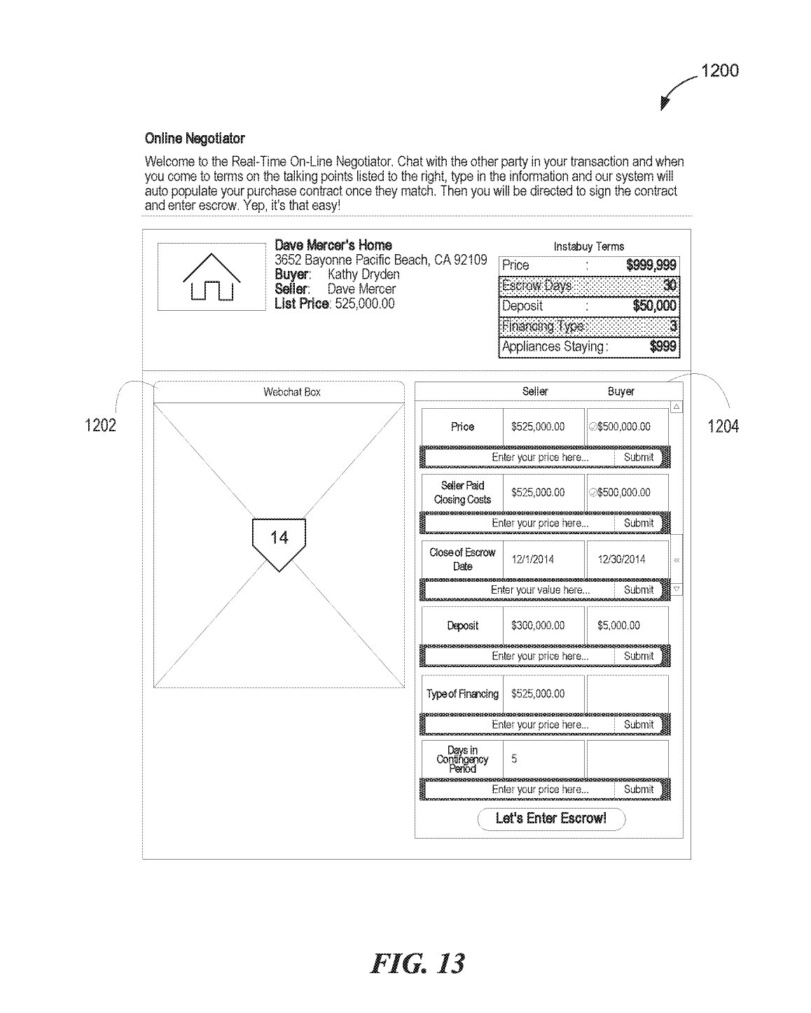

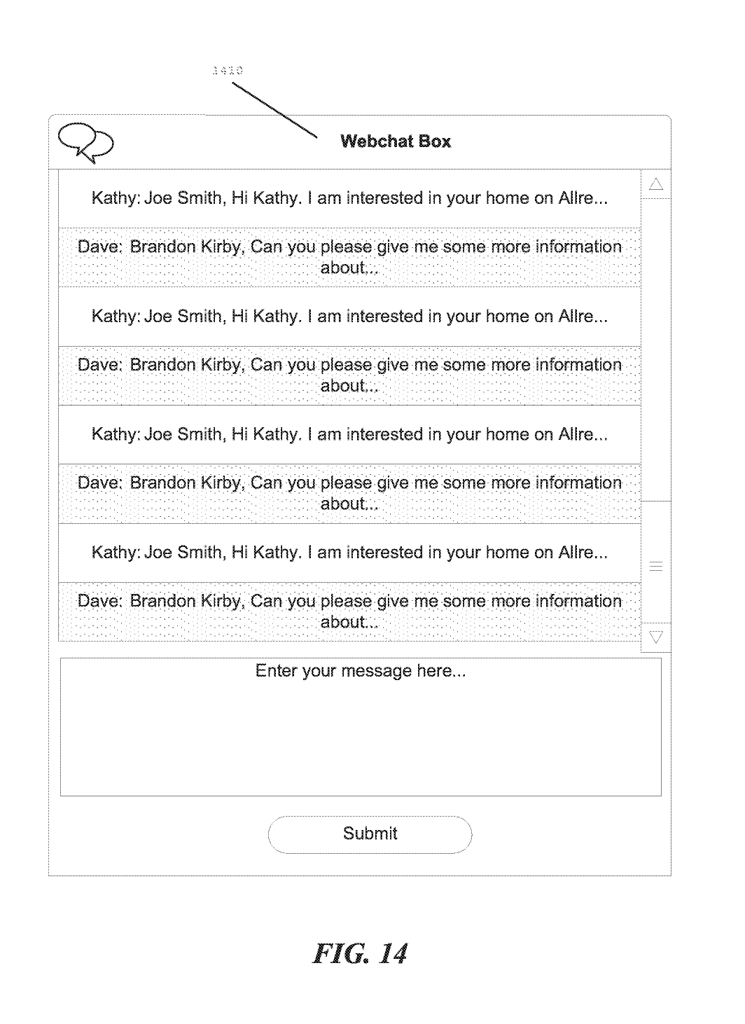

FIG. 13 shows an example of a screen display for a live negotiation being conducted between a seller and a buyer. The screen display includes a live discussion portion, shown as negotiation panel 1202, and a contract term negotiation portion 1204. Further visual details of the display regarding the negotiation panel 1202 are illustrated in FIG. 14. The contract term negotiation panel 1204 includes multiple contract term review sections, which present the terms vertically in the example of FIG. 13. Each contract term review section corresponds to each contract term to be negotiated between the seller and the buyer.

For example, a first contract term review section corresponds to the price term. In this example, the seller has submitted $525,000.00 and the seller has submitted $500,000.00, which satisfies a match condition for the price term. For example, the match condition is defined to be the buyer input being equal to or greater than the seller input. An indicator is located next to the buyer input of $500,000.00 to indicate the match condition has occurred. In another example, a second contract term review section corresponds to the close of escrow date term. In this example, the seller and the buyer can continue submitting a value until a match condition for that date occurs. The match condition can occur, for example, if the buyer submits a date value that is within 5 days of the seller's date value.

FIG. 14 shows an example of a negotiation panel 1410 or screen display for enabling the negotiation panel 1202 of FIG. 13. The negotiation panel 1202 includes a dialog box (e.g., “WebChat Box”) that enables the buyer (e.g., “Dave”) to discuss things related to the purchase of the property with the seller (e.g., “Kathy”).

FIG. 15 shows an example of a screen display 1510 for managing offers on a particular property. The offers illustrated in the screen display of FIG. 15 can be generated in response to one or more interested buyers selecting the Make An Offer option illustrated in FIG. 10. The screen display illustrated in FIG. 15 displays for the seller of the property all offers that have been submitted for the property (e.g., Offer #1 from Dave Dryden and Offer #2 from Will Dryden). The seller has the options to accept, counter, or reject each of the values submitted for each term in a particular offer. For example, the seller can input her own values for one or more terms and select to submit her counter offer with the adjusted terms.

FIG. 16 shows an example of a screen display 1610 for a timetable that can guide participants in a sales transaction through all necessary steps. The timetable display includes a set of time segments that map out the timeframe until completion of the sales transaction. The timetable display also includes the participants involved in the transaction and tasks assigned to the participants and distributed within the timeframe.

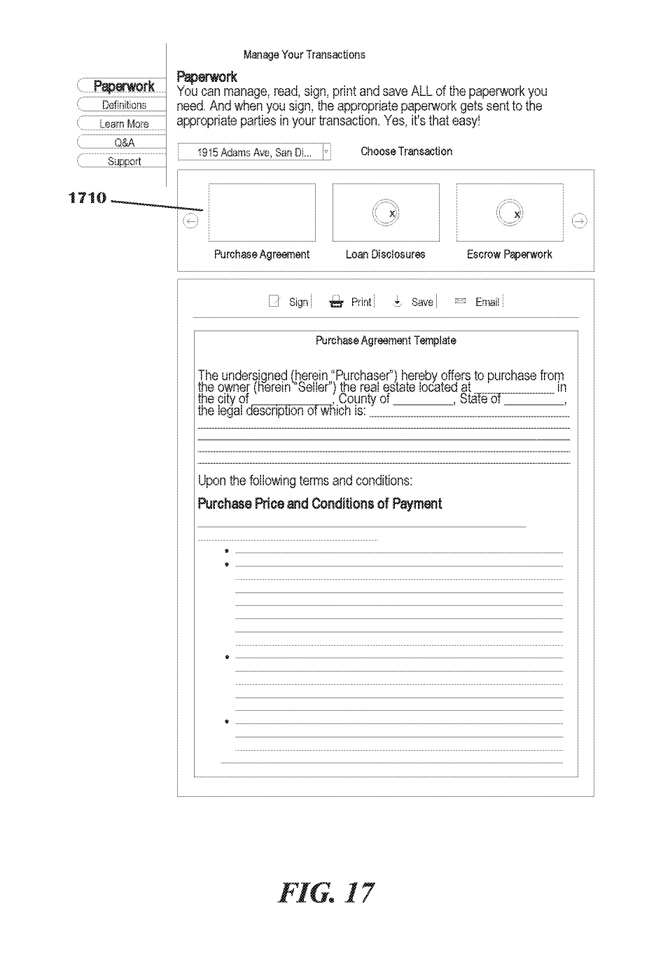

FIG. 17 shows an example of a screen display 1710 for managing documents associated with a sales transaction. A user, such as a buyer or a seller, can manage, read, sign, print and save all of the documents, or paperwork, related to the sales transaction. In some embodiments, upon signing, or execution, of any of the documents electronically (e.g., via the screen display), a computer system (e.g., server 110) causes that executed document to be automatically sent to the appropriate participants or parties in the transaction.

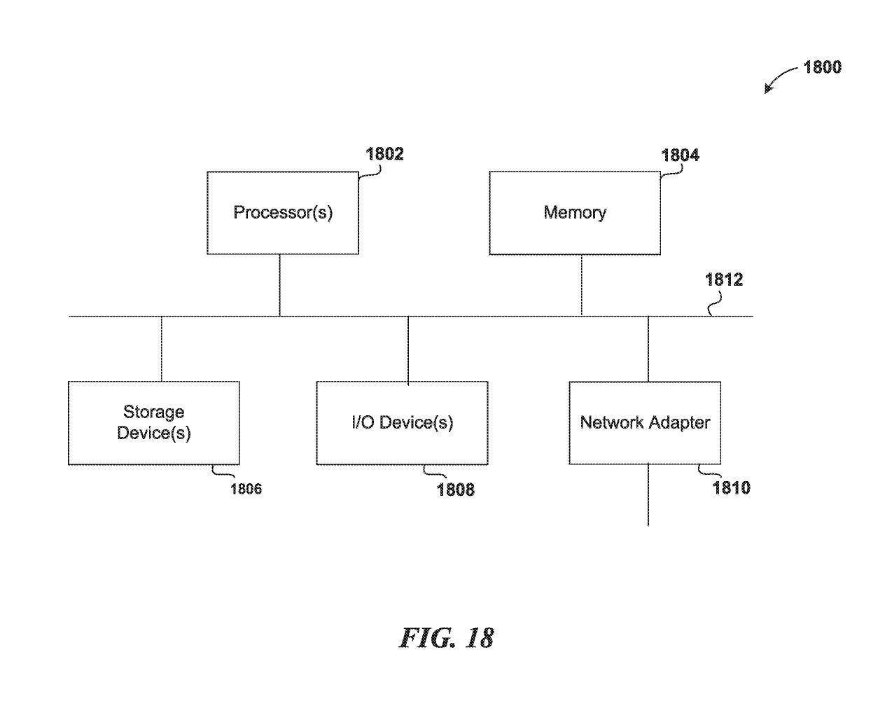

FIG. 18 depicts a diagrammatic representation of a machine in the example form of a computer system 1800 within which a set of instructions, for causing the machine to perform any one or more of the methods discussed herein, can be executed. The computer system 1800 can represent any of the devices described above, such as the buyer device 104, the seller device 106, the server 110, or the server 200. Note that any of these systems may include two or more subsystems or devices, which may be coupled to each other via a network or multiple networks.

In the illustrated embodiment, the computer system 1800 includes one or more processors 1802, memory 1804, one or more storage devices 1806, one or more input/output (I/O) devices 1808, and a network adapter 1810, all coupled to each other through an interconnect 1812. The interconnect 1812 can be or include one or more conductive traces, buses, point-to-point connections, controllers, adapters and/or other conventional connection devices.

The processor(s) 1802 can be or include, for example, one or more general-purpose programmable microprocessors, microcontrollers, application specific integrated circuits (ASICs), programmable gate arrays, or the like, or a combination of such devices. The processor(s) 1802 control the overall operation of the computer system 1800.

The memory 1804 and the storage device(s) 1806 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non-transitory” media) and computer-readable transmission media.

The instructions stored in memory 1804 can be implemented as software and/or firmware to program the processor(s) 1802 to carry out operations described above. In some embodiments, such software or firmware may be initially provided to the computer system 1800 by downloading it from a remote system through the computer system 1800 (e.g., via network adapter 1810).

The network adapter 1810 can be or include, for example, an Ethernet adapter, cable modem, Wi-Fi adapter, cellular transceiver, Bluetooth transceiver, or the like, or a combination thereof. Depending on the specific nature and purpose of the processing device, the I/O devices can include devices such as a display (which may be a touch screen display), audio speaker, keyboard, mouse or other pointing device, microphone, camera, etc.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Unless contrary to physical possibility, it is envisioned that (i) the methods/steps described above may be performed in any sequence and/or in any combination, and that (ii) the components of respective embodiments may be combined in any manner.

As used herein, the terms “connected,” “coupled,” or any variant thereof, means any connection or coupling, either direct or indirect, between two or more elements; the coupling of connection between the elements can be physical, logical, or a combination thereof. As used herein, a “module,” “a manager,” an “interface,” a “platform,” or an “engine” includes a general purpose, dedicated or shared processor and, typically, firmware or software modules that are executed by the processor. Depending upon implementation-specific or other considerations, the module, manager, interface, platform, or engine can be centralized or its functionality distributed. The module, manager, interface, platform, or engine can include general or special purpose hardware, firmware, or software embodied in a computer-readable (storage) medium for execution by the processor.

What is claimed is:

1. A computer system comprising:
a memory to store a set of instructions;
one or more processors to execute instructions stored in the memory to:
provide a negotiation panel for a computing device of each of a buyer and a seller, to enable the buyer and seller to exchange messages over a communication network;
provide a contract term negotiation panel that identifies a list of contract terms open for negotiation between the buyer and the seller;
functionally interrelate the negotiation panel and the contract term negotiation panel, by (i) parsing messages of the negotiation panel to detect a match condition with respect to a material term for a transaction, (ii) identifying a corresponding contract term displayed through the contract negotiation panel for the match condition, and (iii) indicating the corresponding contract term as complete.

2. The computer system of claim 1, wherein the match condition is specified in advance of the buyer and seller exchanging messages.

3. The computer system of claim 2, wherein the match condition corresponds to a rule based condition that is specified by one of the buyer or the seller.

4. The computer system of claim 2, wherein the match condition corresponds to multiple rule based conditions, including a rule based condition that is specified by the buyer and a rule based condition that is specified by the buyer.

5. The computer system of claim 1, wherein the match condition specifies a range for a price.

6. The computer system of claim 1, wherein the match condition specifies a range for a date.

7. The computer system of claim 1, wherein the match condition is satisfied when a value of a price specified by at least one of the buyer or seller exceeds a threshold value.

8. The computer system of claim 1, wherein the match condition is satisfied when a comparison or combination of a value of a price specified by each of the buyer and seller exceeds a threshold value.

9. The computer system of claim 1, wherein the one or more processors further execute the instructions to:
generate a timetable user interface to include a set of time segments and a set of tasks corresponding to the set of time segments, wherein the set of time segments and the set of tasks are generated based on the completed terms.

10. The computer system of claim 1, wherein the one or more processors further execute the instructions to:
determine a set of tasks for a set of participants associated with a transaction of the buyer and the seller, wherein each task in the set of tasks is associated with a task due date and also associated with a participant of the set of participants for completion.

11. A method for conducting a transaction between parties of a transaction, the method being implemented by one or more processors and comprising:
providing a negotiation panel for a computing device of each of a buyer and a seller, to enable the buyer and seller to exchange messages over a communication network;
providing a contract term negotiation panel that identifies a list of contract terms open for negotiation between the buyer and the seller;
functionally interrelating the negotiation panel and the contract term negotiation panel, by (i) parsing messages of the negotiation panel to detect a match condition with respect to a material term for the transaction, (ii) identifying a corresponding contract term displayed through the contract negotiation panel for the match condition, and (iii) indicating the corresponding contract term as complete.

12. The method of claim 11, wherein the match condition is specified in advance of the buyer and seller exchanging messages.

13. The method of claim 12, wherein the match condition corresponds to a rule based condition that is specified by one of the buyer or the seller.

14. The method of claim 12, wherein the match condition corresponds to multiple rule based conditions, including a rule based condition that is specified by the buyer and a rule based condition that is specified by the buyer.

15. The method of claim 11, wherein the match condition specifies a range for a price.

16. The method of claim 11, wherein the match condition specifies a range for a date.

17. The method of claim 11, wherein the match condition is satisfied when a value of a price specified by at least one of the buyer or seller exceeds a threshold value.

18. The method of claim 11, wherein the match condition is satisfied when a comparison or combination of a value of a price specified by each of the buyer and seller exceeds a threshold value.

19. The method of claim 11, further comprising:
generating a timetable user interface to include a set of time segments and a set of tasks corresponding to the set of time segments, wherein the set of time segments and the set of tasks are generated based on the completed terms.

20. A non-transitory computer readable medium that stores instructions, which when executed by one or more processors of a computer system, cause the computer system to perform operations comprising:
providing a negotiation panel for a computing device of each of a buyer and a seller, to enable the buyer and seller to exchange messages over a communication network;
providing a contract term negotiation panel that identifies a list of contract terms open for negotiation between the buyer and the seller;
functionally interrelating the negotiation panel and the contract term negotiation panel, by (i) parsing messages of the negotiation panel to detect a match condition with respect to a material term for the transaction, (ii) identifying a corresponding contract term displayed through the contract negotiation panel for the match condition, and (iii) indicating the corresponding contract term as complete.
